(19) United States
(12) Patent Application Publication
(10) Pub. No.: US 2006/0099945 A1
(43) Pub. Date: May 11, 2006

(54) Using PIM calendar on a mobile device to configure the user profile

(75) Inventor: Richard Eric Helvick, Portland, OR (US)

Correspondence Address: ROBERT D. VARITZ, 4915 S.E. 33RD PLACE, PORTLAND, OR, 97202, US

(73) Assignee: Sharp Laboratories of America, Inc.

(21) Appl. No.: 10/985,220

(22) Filed: Nov. 9, 2004

(51) Int. Cl. H04Q 7/20

(52) U.S. Cl. 455/432.3

(57) ABSTRACT

A method of automatically changing a user profile in a mobile communication device, wherein the mobile communication device is equipped with a calendar mechanism, including setting a number of user profiles in the mobile communication device; setting an event begin time and an event end time in the calendar mechanism; selecting a user profile to be in use during the event; detecting the beginning time for the event; recording and storing the user profile in effect prior to the event begin time; activating the selected user profile to be in use during the event; and detecting the end time for the event and restoring the user profile in effect prior to the event begin time.

### FIELD OF THE INVENTION

This invention relates to mobile communication devices, and specifically to the provision of a calendar equipped mobile communication device wherein the calendar is used to change selected user profiles according to scheduled events.

### BACKGROUND OF THE INVENTION

Modern mobile communication devices, such as mobile phones, PDAs, etc., have a feature called a “profile,” which allows the user to specify settings for various options of the device which affect its behavior for alerting the user to various incoming calls and messages. These profiles are used to quiet the device when the user is in a meeting, for example. To set this option, the user generally must access the device's UI and select the desired option. Many mobile communication devices contain some form of basic Personal Information Manager (PIM), which likely includes a user's calendar for scheduling events. This invention makes use of a user's calendar to automatically set a select a user profile, i.e., a profile specific to the user of the mobile communication device, according to the events in the calendar. Although many patents describe various uses of an embedded calendar or scheduling mechanism, a teaching of a profile option driven by a calendar is not known in the prior art.

U.S. Pat. No. 6,668,177 to Salmimaa et al., granted Dec. 23, 2003, for Method and apparatus for displaying prioritized icons in a mobile terminal, describes using the time of day or the user profile to determine which icons to display.

U.S. Pat. No. 6,662,199 to Flight et al., granted Dec. 9, 2003, for Method and apparatus for customized hosted applications, describes use of a base table and a user table to retrieve settings for applications.

U.S. Pat. No. 6,658,268 to Bodnar et al., granted Dec. 2, 2003, for Enhanced companion digital organizer for a cellular phone device, describes attaching an external device to a mobile phone which will give the mobile the functionality of a “smart phone.”

U.S. Pat. No. 6,553,100 to Chen et al., granted Apr. 22, 2003, for Intelligent alerting systems, describes the use of an intelligent processor to route alerts to various devices and to detect and handle alerts during a device malfunction.

U.S. Pat. No. 6,480,830 to Ford et al., granted Nov. 12, 2002, for Active calendar system, describes use of an active calendar that generates a machine readable file for use by an external resource(s), related to calendar entries.

U.S. Pat. No. 6,477,374 to Shaffer et al., granted Nov. 5, 2002, for Apparatus and method for calendar based call routing, describes the use of a user calendar, which is queried when a call reaches the PBX, to determine where to forward the call.

U.S. Pat. No. 6,459,913 to Cloutier, granted Oct. 1, 2002, for Unified alerting device and method for alerting a subscriber in a communication network based upon the result of logical functions, describes a method using a user profile to filter alerts to one or more user devices.

U.S. Pat. No. 6,640,230 to Alexander et al., granted Oct. 28, 2003, for Calendar-driven application technique for preparing responses to incoming events, describes use of a calendar to determine how to handle income messages, e.g., EMail, voice calls, etc. An EMail application may, e.g., detect from the calendar that the user is on vacation and automatically set an “out of office” flag.

U.S. Pat. No. 6,618,716 to Horvitz, granted Sep. 9, 2003, for Computational architecture for managing the transmittal and rendering of information, alerts, and notifications, describes an architecture for handling alerts and notifications to the user. This system throttles the notifications to prevent the user from being bombarded by information.

U.S. Pat. No. 6,085,098 to Moon et al, granted Jul. 4, 2000, for Apparatus and method for automatically configuring settings of a software application in a portable intelligent communications device, describes configuring the settings of an application on a portable device based on the geographical location of the device.

U.S. Pat. No. 5,933,778 to Buhrmann et al., granted Aug. 3, 1999, for Method and apparatus for providing telecommunication services based on a subscriber profile updated by a personal informational manager, describes the use of a PIM on a device to generate a profile of the user, which may be used by a network to control telecommunication services.

### SUMMARY OF THE INVENTION

A method of automatically changing a user profile in a mobile communication device, wherein the mobile communication device is equipped with a calendar mechanism, including setting a number of user profiles in the mobile communication device; setting an event begin time and an event end time in the calendar mechanism; selecting a user profile to be in use during the event; detecting the beginning time for the event; recording and storing the user profile in effect prior to the event begin time; activating the selected user profile to be in use during the event; and detecting the end time for the event and restoring the user profile in effect prior to the event begin time.

It is an object of the invention to provide a calendar-equipped mobile device, wherein the device automatically selects a predetermined option based on calendar events.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the method of the invention.

### DETAILED DESCRIPTION OF THE PREFERRED EMBODIMENTS

The method of the invention links a scheduled event in a calendar to a user profile, so that the mobile communication device automatically sets itself to the desired user profile for that time period. The user's calendar controls selection of a profile in the phone, allows the user, or a control system, to schedule a meeting in the calendar and know that the mobile device will automatically change its settings at that time, and then change back to the user's default settings when the scheduled event is scheduled to be complete.

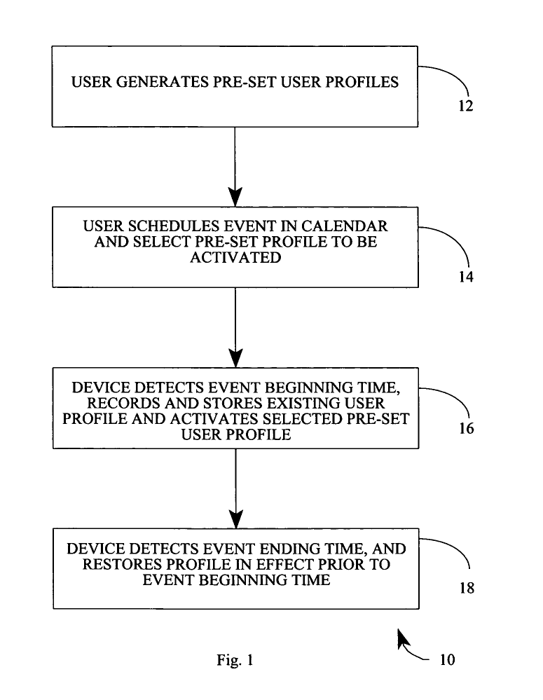

Referring now to FIG. 1, the method of the invention is depicted generally at 10. A user sets up a number of pre-set profiles, 12, in a mobile communication device to accommodate the user's desires depending on the user's environment. When the user schedules an appointment, an event, in the mobile communication device's calendar, a field is provided wherein the user is asked to select one of the pre-set profiles for use during the designated event's time period, 14. When the scheduled event time occurs, the mobile communication device records the current, existing profile and activates the profile selected by the user when setting the event, 16. When the event end time is reached, the mobile communication device restores the profile in effect prior to the event beginning time, 18.

Of course, user profiles may not need to be set manually by a user. A mobile communication device is likely programmed with default profiles, e.g., “Silent mode during calendar events.” The user may select the desired default profiles during an initial set-up process, or simply leave the default profiles as active. Further, in many instances, a control system is provided by a user's environment, e.g., a central calendar control, which is used to set appointments for one or more persons working in the environment. Thus, a calendar event may be set by a control system or by the user. User profiles may also be set by the control system to insure that everyone participating in a calendar event has quiet mobile communication devices. A number of communication devices may thus be set, or synchronized, by a control system, and the actual mobile communication devices set by means of cable connection, RF, IR, Bluetooth®, or other protocols.

As an example, if the user has a meeting on Thursday from 1:30 pm to 2:30 pm, the user enters the appointment in the mobile communication device's calendar and selects which user profile is to be in use during the designated time period for the appointment. One of the options given for that event is the user profile to be in use during that time period. The user is able to set this option to any of the user profiles on the mobile device. For instance, one of the pre-set profiles may direct all callers to a voice mail box which notifies the caller that the user is in a meeting, and the same pre-set profile also silences the ring on the phone. When the time for the event arrives, the mobile device records the current user profile and changes the settings to those listed in the calendar entries profile. When the scheduled event's time is over, the mobile device then changes the settings back to the setting recorded before the meeting scheduled time.

In an alternate embodiment of the method of the invention, the user may be notified of the impending profile change, e.g. in a pop-up window on the UI and/or an audible indication. This is particularly convenient in the case where a control system is used to set calendars without intervention by the user of the mobile communication device.

Thus, a method for using an mobile device calendar to change selected mobile device options has been disclosed. It will be appreciated that further variations and modifications thereof may be made within the scope of the invention as defined in the appended claims.

1. A method of automatically changing a user profile in a mobile communication device, wherein the mobile communication device is equipped with a calendar mechanism, comprising:
setting a number of user profiles in the mobile communication device;
setting an event begin time and an event end time in the calendar mechanism;
selecting a user profile to be in use during the event;
detecting the beginning time for the event;
recording and storing the user profile in effect prior to the event begin time; and
activating the selected user profile to be in use during the event.

2. The method of claim 1 which includes detecting the end time for the event and restoring the user profile in effect prior to the event begin time.

3. The method of claim 1 which further includes providing notification to the user before activating the selected user profile.

4. The method of claim 1 wherein said setting a number of user profiles in the mobile communication device includes selecting a user profile from the methods of setting a user profile consisting of selecting a default user profile, manually setting a user profile by the user, and setting a user profile by a control system.

5. The method of claim 1 wherein said setting an event begin time and an event end time includes selecting an event begin time and an event end time by the user and selecting an event begin time and an event end time by a control system.

6. A method of automatically changing a user profile in a mobile communication device, wherein the mobile communication device is equipped with a calendar mechanism, comprising:
setting a number of user profiles in the mobile communication device;
setting an event begin time and an event end time in the calendar mechanism;
selecting a user profile to be in use during the event;
detecting the beginning time for the event;
recording and storing the user profile in effect prior to the event begin time;
activating the selected user profile to be in use during the event;
detecting the end time for the event and restoring the user profile in effect prior to the event begin time; and
providing notification to the user before activating the selected user profile.

7. The method of claim 6 wherein said setting a number of user profiles in the mobile communication device includes selecting a user profile from the methods of setting a user profile consisting of selecting a default user profile, manually setting a user profile by the user, and setting a user profile by a control system.

8. The method of claim 6 wherein said setting an event begin time and an event end time includes selecting an event begin time and an event end time by the user and selecting an event begin time and an event end time by a control system.

9. A method of automatically changing a user profile in a mobile communication device, wherein the mobile communication device is equipped with a calendar mechanism, comprising:
setting a number of user profiles in the mobile communication device;
setting an event begin time and an event end time in the calendar mechanism;
selecting a user profile to be in use during the event;
detecting the beginning time for the event;
recording and storing the user profile in effect prior to the event begin time;
activating the selected user profile to be in use during the event, wherein the pre-set profiles are taken from the group of profiles consisting of silencing and forwarding to voice mail; and
detecting the end time for the event and restoring the user profile in effect prior to the event begin time.

10. The method of claim 9 which includes providing notification to the user before activating the selected user profile.

11. The method of claim 9 wherein said setting a number of user profiles in the mobile communication device includes selecting a user profile from the methods of setting a user profile consisting of selecting a default user profile, manually setting a user profile by the user, and setting a user profile by a control system.

12. The method of claim 9 wherein said setting an event begin time and an event end time includes selecting an event begin time and an event end time by the user and selecting an event begin time and an event end time by a control system.
